(19) United States
(12) Patent Application Publication
(10) Pub. No.: US 2015/0030735 A1
(43) Pub. Date: Jan. 29, 2015

(54) ALOE VERA COATING OF POTATO CHIPS

(71) Applicants: Kashif Sarfraz ABBASI, Haripur (PK); Tariq Masud, Rawalpindi (PK); Sartaj Ali, Gilgit (PK); Muhammad Jahangir, Haripur (PK)

(72) Inventors: Kashif Sarfraz ABBASI, Haripur (PK); Tariq Masud, Rawalpindi (PK); Sartaj Ali, Gilgit (PK); Muhammad Jahangir, Haripur (PK)

(21) Appl. No.: 13/952,174

(22) Filed: Jul. 26, 2013

(51) Int. Cl. A23L 1/217; A23L 1/01

(52) U.S. Cl. CPC A23L 1/217; A23L 1/0107
USPC 426/305; 426/548

(57) ABSTRACT

A composition for dip-sealing potato chips prior to frying to reduce the absorption of fats into potato chips.

### BACKGROUND OF THE INVENTION

Potato products, especially chips are oil rich (35-40%) products and considered a preferred snack food worldwide due to its palatable taste and ease of preparation. High oil contents are of grave concern for people suffering from chronic heart disease and obesity.

Whereas industrial concerns of high fat content means economic loss, different techniques like, modification in size and thickness, pre-drying, modification in frying techniques, frying medium, frying temperature and potato chips coatings have been employed to minimize oil content in the thermally processed products.

Since the oil uptake during frying of potato chips is largely the function of its surface properties, coating is considered a promising route for its mitigation in the finished processed product. The coating with cellular derivatives causes the formation of a protective layer on the surface and eventually decreases the oil uptake in the fried products. In addition, pre-processing coating on potato products are reported to mitigate likely acrylamide formation in the processed products.

Aloe Vera is known for its therapeutic and medicinal properties. Its mucilage gel extracted from leaf parenchymatic cell predominantly being used for a long time against cardio vascular diseases, ulcer, gastro-intestinal and renal disorders. The use of Aloe Vera gel has also been increasing in cosmetic industry and is known to carry antifungal activity.

Aloe Vera is increasingly being used as a functional ingredient in food industries for ice creams, beverages and dessert production. It is reported to carry specific barrier properties and is used as post-harvest edible coating to increase the shelf life of Cherries and table grapes.

### BRIEF SUMMARY OF THE INVENTION

Selection of Aloe Vera gel for chip coating in the present study has been carried out as a novel technique in potato processing to reduce fat uptake of chips during frying, and develop a plant based HALAL (permissible in Islamic jurisprudence) coating material, with appreciable retention of sensorial attributes. Such high quality processed product would equally be appreciated by the processor and consumer due to added economic and health benefits.

### BRIEF DESCRIPTION OF THE DRAWING

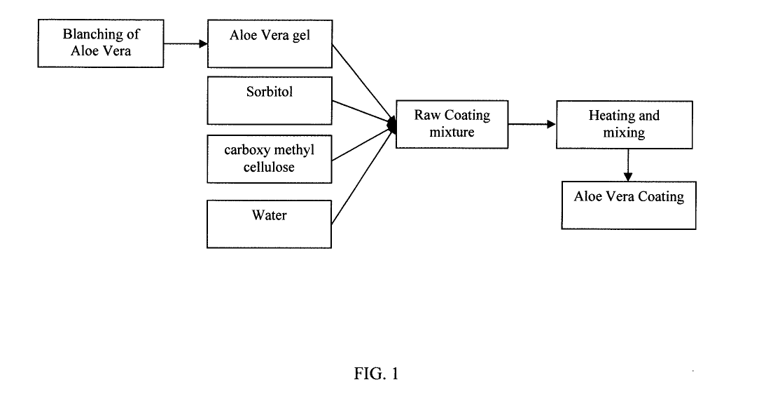

The FIG. 1 is an illustration in the form of a flow diagram to prepare Aloe Vera coating material.

### DETAILED DESCRIPTION OF THE INVENTION

Potato variety “Lady Rosetta” was harvested from Potato Research Institute, Sahiwal (Punjab, Pakistan) in January 2011. The experimental material was shifted to the Post harvest Technology Lab. Food Technology Department, PMAS-Arid Agriculture University, Rawalpindi. Potatoes were washed, sorted and graded into homogenous lot.

The gel was extracted from freshly harvested Aloe Vera leaves and blanched at 60-80° C. for 5-10 minutes. Aloe Vera gel coating was prepared in different formulations with Aloe Vera gel (10-40%), sorbitol (0.5-3%) and carboxy methyl cellulose (0.3-1.5%) added as plasticizers along with distilled water. Different concentrations (10-40%) of Aloe Vera gel coating performed satisfactory as a coating material on potato chips to reduce fat absorption, with acceptable sensory attributes.

Peeled potato tubers were sliced (1.2-1.5 mm thick) and blanched in 1.5% NaCl solution at 85° C. for two minutes.

The potato chips were dipped in prepared formulations of Aloe Vera coating for 5 minutes, allowed to drip off and dried before frying. After pre drying the chips were fried.

What is claimed is:

1. A potato chip dip-coating composition comprising an aqueous paste of aloe vera gel, sorbitol and carboxymethyl cellulose.

2. The potato chip dip-coating composition of claim 1, wherein the concentration of aloe vera gel ranges between 10 to 40 percent of the paste.

3. The potato chip dip-coating composition of claim 1, wherein the concentration of sorbitol is 0.5 to 3 percent of the paste.

4. The potato chip dip-coating composition of claim 1, wherein the concentration of carboxymethyl cellulose is between 0.3 to 1.5 percent of the paste.

5. A method for reducing absorption of fat in potato chips comprising dipping the potato chips in the paste of claim 1, prior to frying.
